(19) United States
(12) Patent Application Publication
(10) Pub. No.: US 2011/0017541 A1
(43) Pub. Date: Jan. 27, 2011

(54) Small Vehicle

(76) Inventor: Rong-Fang HE, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/510,238

(22) Filed: Jul. 27, 2009

(51) Int. Cl. B60K 5/00; A47C 31/00

(52) U.S. Cl. 180/291; 297/229

(57) ABSTRACT

A small vehicle includes a chassis, a seat post supported on the chassis, a pivotal frame pivotally connected to the chassis, a rear cushion provided between the seat post and the pivotal frame, a motor provided on the pivotal frame, two rear wheels driven with the motor, an upper shell for covering most of the elements and a lower shell for covering only the motor.

### BACKGROUND OF INVENTION

1. Field of Invention

The present invention relates to a small vehicle and, more particularly, to a small vehicle with an upper shell for covering most elements thereof and a lower shell for covering only a motor thereof so that easy access to the motor and a rear cushion is allowed.

2. Related Prior Art

Referring to FIG. 4, a conventional small vehicle includes a chassis 90 and a seat post 91 secured to the chassis 90 by welding for example so that the chassis 90 and the seat post 91 become one. When driven on rough ground, a large portion of vibration encountered by wheels is transferred to the seat post 91 through the chassis 90. Thus, a driver feels most of the vibration.

There are attempts to provide a cushion between a chassis and a rear wheel-supporting axle. There are however problems as follows:

Firstly, the stroke of the cushion is limited so that the cushioning effect is comprised.

Secondly, a shell must be removed from the small vehicle so that the cushion and a motor can be maintained or repaired. The shell is attached to the small vehicle again after the maintenance or repair. This process is inconvenient.

Therefore, the present invention is intended to obviate or at least alleviate the problems encountered in prior art.

### SUMMARY OF INVENTION

It is the primary objective of the present invention to provide a small vehicle with an easily accessible rear cushion and motor.

To achieve the foregoing objective, the small vehicle includes a chassis, a seat post supported on the chassis, a pivotal frame pivotally connected to the chassis, a rear cushion provided between the seat post and the pivotal frame, a motor provided on the pivotal frame, two rear wheels driven with the motor, an upper shell for covering most of the elements and a lower shell for covering only the motor.

Other objectives, advantages and features of the present invention will be apparent from the following description referring to the drawings.

### BRIEF DESCRIPTION OF DRAWINGS

The present invention will be described via detailed illustration of the preferred embodiment versus the prior art referring to the drawings.

FIG. 1 is a perspective view of a small vehicle according to the preferred embodiment of the present invention.

FIG. 2 is a perspective, partial view of the small vehicle of FIG. 1.

FIG. 3 is a side, partial view of the small vehicle shown in FIG. 1.

FIG. 4 is a cutaway, partial view of the small vehicle shown in FIG. 1.

FIG. 5 is another perspective, partial v(Dew of the small vehicle shown in FIG. 1.

FIG. 6 is a perspective, partial view of a conventional small vehicle.

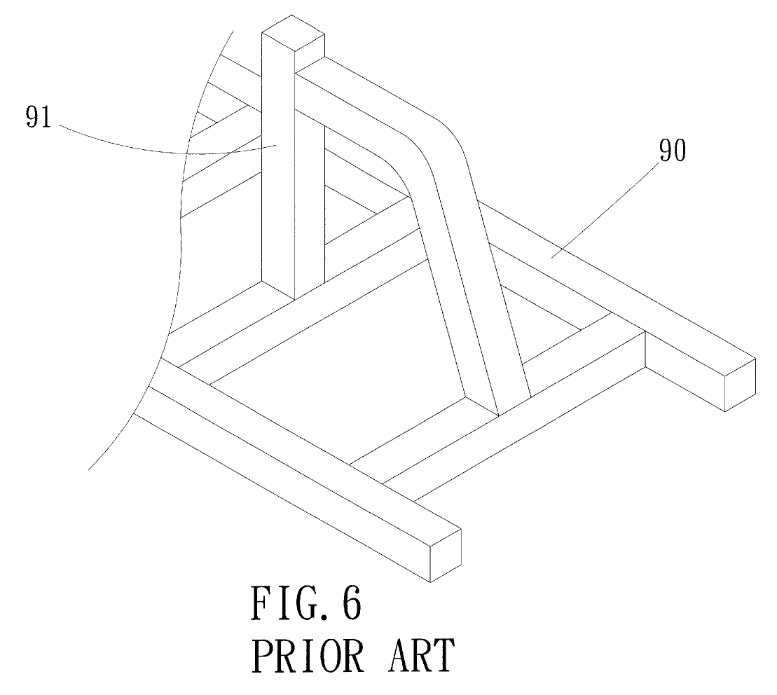

### DETAILED DESCRIPTION OF PREFERRED EMBODIMENT

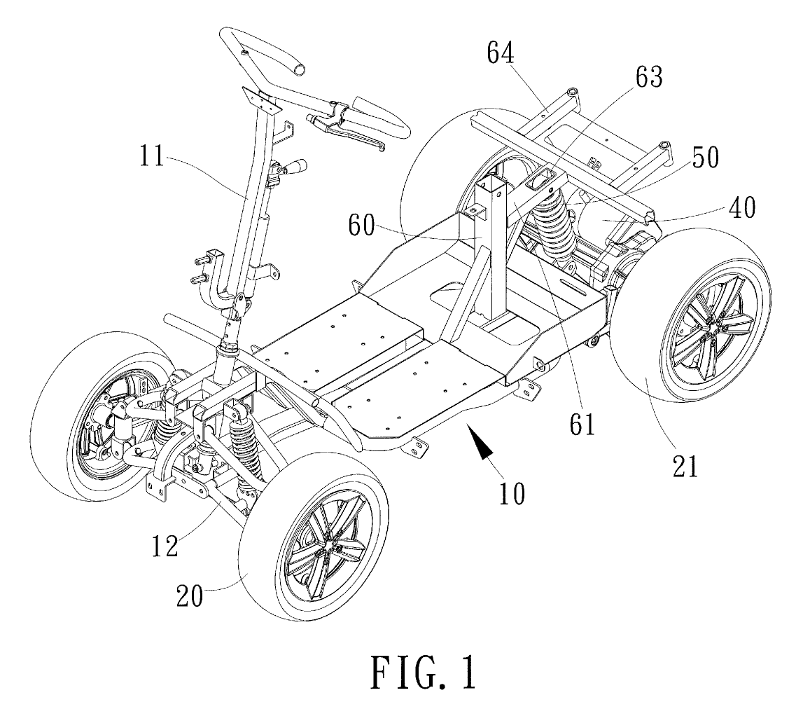

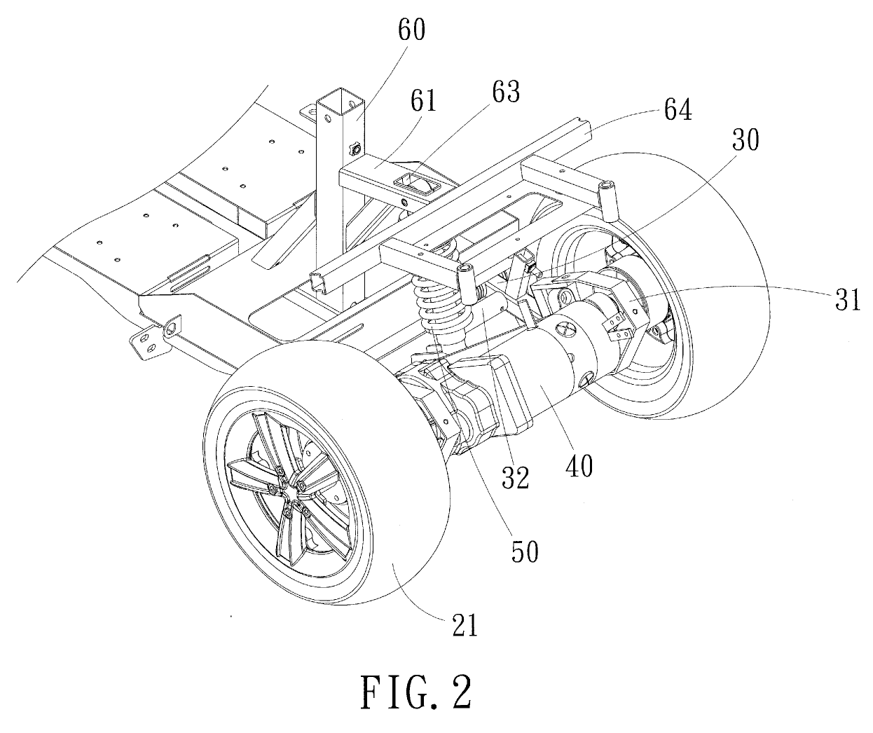

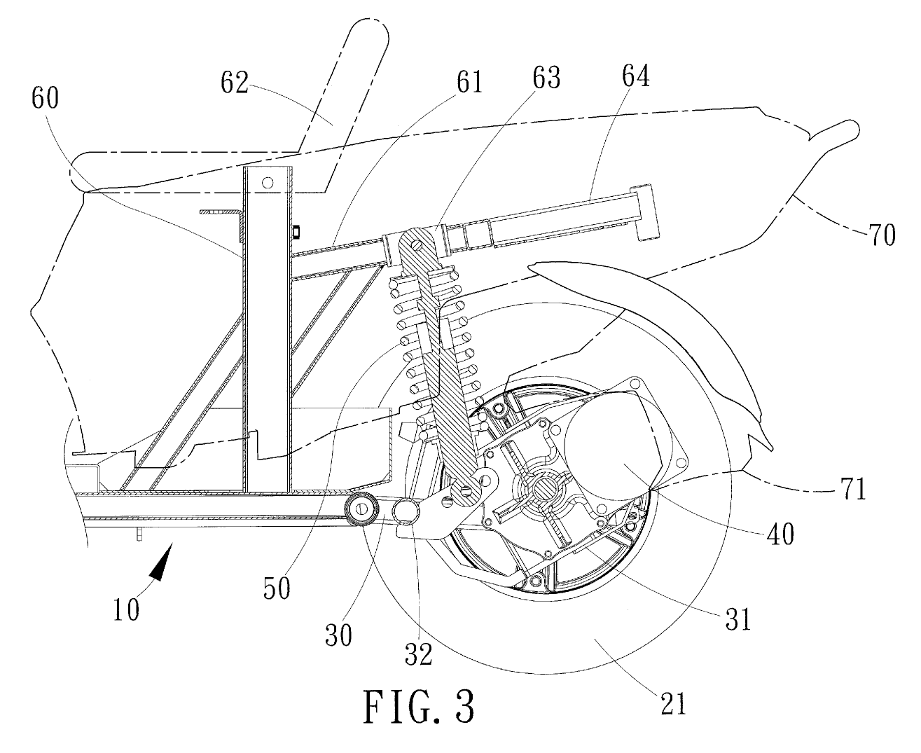

Referring to FIGS. 1 through 3, a small vehicle includes a chassis 10, two front wheels 20, a front suspending unit 12 provided between the chassis 10 and the front wheels 20, a pivotal frame 30 pivotally connected to the chassis 10, a rear cushion 50 for cushioning the pivotal frame 30, a motor 40 provided on the pivotal frame 30, two rear wheels 21 driven with the motor 40 through a transmission, a seat post 60 supported on the chassis 10, an upper shell 70 for covering most of the elements and a lower shell 71 for covering the motor 40 according to the preferred embodiment of the present invention. A steering mechanism 11 is connected to the front suspending unit 12 so that the front wheels 20 can be steered by maneuvering the steering mechanism 11.

The rear wheels 21 are rotationally supported on the pivotal frame 30 that can be pivoted relative to the chassis 10 so that only a small portion of vibration encountered by the rear wheels 21 is transferred to the seat post 60 through the chassis 10. The pivotal frame 30 includes two longitudinal beams and a crossbar 32 provided between the longitudinal beams. A motor frame 31 is connected to the longitudinal beams of the pivotal frame 30. The motor 40 is supported on the motor frame 31. A lower end of the rear cushion 50 is pivotally connected to the crossbar 32.

The seat post 60 is located in front of the pivotal frame 30. A seat or chair 62 is supported on the seat post 60. A cantilever 61 is extended from the seat post 60. The cantilever 61 includes an aperture 63 for receiving an upper end of the rear cushion 50. A pin is driven in the upper end of the rear cushion 50 through the cantilever 61, thus pivotally connecting the rear cushion 50 to the seat post 60. A shell frame 64 is secured to the cantilever 61.

The upper shell 70 is attached to the shell frame 64 and the seat post 60, thus covering most of the elements. The upper shell 70 preferably includes two halves that are made separately and later joined together. The lower shell 71 is attached to the motor frame 31, thus covering the motor 40. The lower shell 71 is separated from the upper shell 70 so that a long stroke of the rear cushion 50 is allowed. Furthermore, access to the motor 40 and the rear cushion 50 is easy because only the lower shell 71 has to be removed. The lower shell 71 is separated from the upper shell 70, thus protectively avoiding unnecessary exposure of the motor 40 to external forces. Similarly, the lower shell 71 preferably includes two halves that are made separately and later joined together.

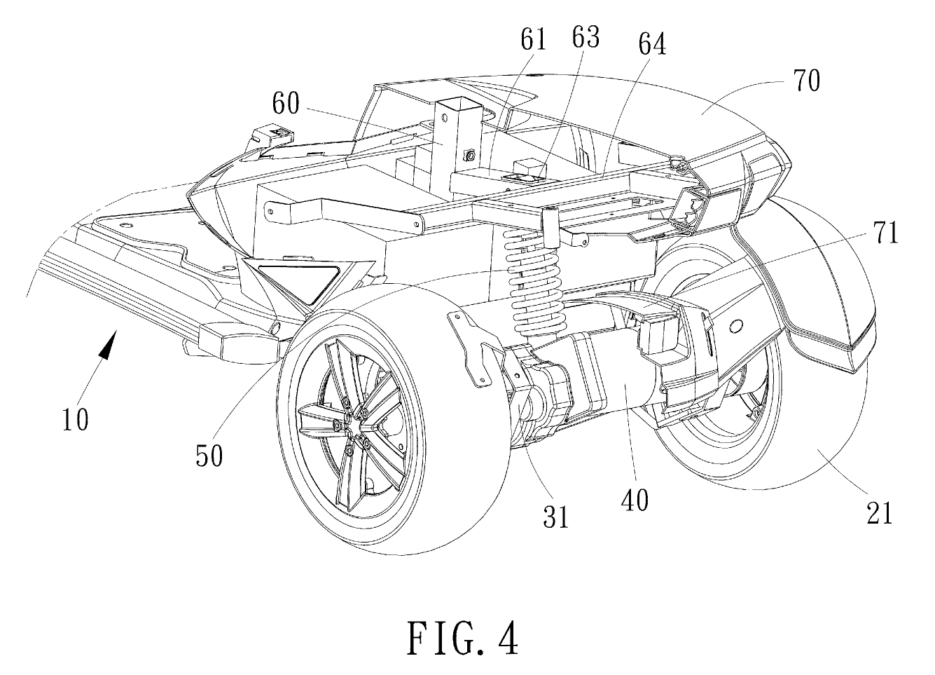

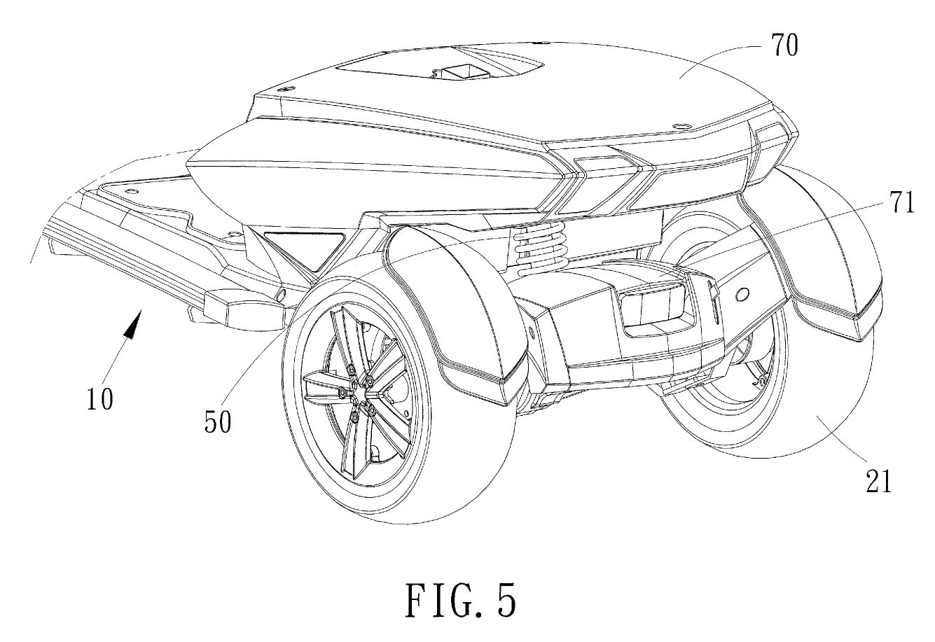

The motor 40 and the rear cushion 50 are located between the rear wheel 21 and the seat 62. To get rid of problems with the transmission, troubleshooting often begins with this region. For example, as shown in FIGS. 4 and 5, from a gap between the upper sell 70 and the lower shell 71, the rear cushion 50 and nearby elements are checked. If nothing is wrong with the rear cushion 50 and/or any of the nearby elements, the lower shell 71 will be detached from the motor frame 31 and the motor 40 will be checked and repaired. The lower shell 71 can be attached to the motor frame 31 soon after the check and repair. There is no need to detach and attach the upper shell 70 again. Hence, the detachment and re-attachment of the lower shell 71 can be fast, thus reducing the time of exposure of the motor 40 to external forces.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A small vehicle comprising:
a chassis;
a seat post supported on the chassis;
a pivotal frame pivotally connected to the chassis;
a rear cushion provided between the seat post and the pivotal frame;
a motor provided on the pivotal frame;
two rear wheels driven with the motor;
an upper shell for covering most of the elements; and
a lower shell for covering only the motor.

2. The small vehicle according to claim 1 comprising a cantilever extended from the seat post, wherein the rear cushion is pivotally connected to the cantilever.

3. The small vehicle according to claim 2, wherein the cantilever comprises an aperture for receiving an upper end of the rear cushion.

4. The small vehicle according to claim 1 comprising a motor frame connected to the pivotal frame, wherein the motor is supported on the motor frame.
